(19) United States
(12) Patent Application Publication
(10) Pub. No.: US 2026/0122292 A1
(43) Pub. Date: Apr. 30, 2026

(54) METHOD AND APPARATUS FOR OBTAINING CAMERA DATA, AUGMENTED REALITY DEVICE, AND STORAGE MEDIUM

(71) Applicant: GOERTEK INC, Weifang (CN)

(72) Inventors: Baoicheng Li, Weifang (CN); Mingming YANG, Weifang (CN); Yuying WANG, Weifang (CN); Jin WU, Weifang (CN); Qinghe YANG, Weifang (CN); Xudong QIU, Weifang (CN); Yaocheng LIU, Weifang (CN)

(21) Appl. No.: 19/427,088

(22) Filed: Dec. 19, 2025

Related U.S. Application Data
(63) Continuation of application No. PCT/CN2025/093101, filed on May 7, 2025.

(30) Foreign Application Priority Data
Jun. 26, 2024 (CN) 202410841010.1

(51) Int. Cl. H04N 21/2187; G06F 3/14; H04N 21/239; H04N 23/661

(52) U.S. Cl. CPC H04N 21/2187; G06F 3/1454; H04N 21/2393; H04N 23/661

(57) ABSTRACT

A method for obtaining camera data includes: receiving a camera access request, and taking a camera requested to be accessed as a target camera; if the target camera is not in use when the camera access request is received, running a system camera support component, obtaining an image stream captured by the target camera through the system camera support component, obtaining camera data of the target camera from the image stream, and copying the image stream to obtain an image stream replica; or if the target camera is already in use when the camera access request is received, running the system camera support component, and obtaining the camera data of the target camera from the image stream replica through the system camera support component.

### CROSS-REFERENCE TO RELATED APPLICATIONS

The present application is a continuation application of International Application No. PCT/CN2025/093101, filed on May 7, 2025, which claims priority to Chinese Patent Application No. 202410841010.1, filed on Jun. 26, 2024. The disclosures of the above-mentioned applications are incorporated herein by reference in their entireties.

### TECHNICAL FIELD

The present application relates to the technical field of augmented reality, and in particular to a method and an apparatus for obtaining camera data, an augmented reality device, and a storage medium.

### BACKGROUND

Augmented reality (AR) devices can overlay real-world environments and virtual videos onto the same screen or space in real time for the wearer to view. Common AR devices include AR glasses or AR helmets.

However, current AR device camera systems only support one process using the same camera. That is, only one process is allowed to obtain the camera data captured by the camera. For example, if an AR device uses a certain camera for gesture control, it cannot use the same camera for barcode scanning, object tracking, etc. Other processes will be disconnected from the previous process through certain strategies to ensure that the same camera is used by only one process.

### SUMMARY

The main purpose of the present application is to provide a method and an apparatus for obtaining camera data, an augmented reality device, and a storage medium, in order to solve the technical problem that the same camera in current AR devices can only be used by one process.

To achieve the above objectives, the present application provides a method for obtaining camera data, which is applied to an augmented reality device. The method includes the following steps:
receiving a camera access request, and taking a camera requested to be accessed as a target camera;
in response to that the target camera is not in use when the camera access request is received, running a system camera support component, obtaining an image stream captured by the target camera through the system camera support component, obtaining camera data of the target camera from the image stream, and copying the image stream to obtain an image stream replica; or
in response to that the target camera is already in use when the camera access request is received, running the system camera support component, and obtaining the camera data of the target camera from the image stream replica through the system camera support component.

In an embodiment, the obtaining the image stream captured by the target camera includes:
obtaining all configuration parameter groups according to the camera access request, wherein each configuration parameter group includes one or more configuration parameters;
configuring a camera configuration stream according to each configuration parameter group, wherein each configuration parameter group corresponds to one camera configuration stream;
selecting one camera configuration stream from all the camera configuration streams, and taking the selected camera configuration stream as a target camera configuration stream; and
obtaining the image stream captured by the target camera based on the target camera configuration stream.

In an embodiment, the selecting one camera configuration stream from all the camera configuration streams, and taking the selected camera configuration stream as the target camera configuration stream includes:
taking, as the target camera configuration stream, the camera configuration stream configured based on configuration parameters encapsulated in the camera access request among all the camera configuration streams.

In an embodiment, the obtaining the camera data of the target camera from the image stream replica includes:
obtaining all pre-configured camera configuration streams, and selecting a first camera configuration stream from all the camera configuration streams; and
obtaining the camera data of the target camera from the image stream replica based on the first camera configuration stream.

In an embodiment, the selecting the first camera configuration stream from all the camera configuration streams includes:
obtaining first configuration parameters encapsulated in the camera access request; and
taking, as the first camera configuration stream, the camera configuration stream with a highest matching degree with the first configuration parameters among all the camera configuration streams, wherein the more configuration parameters in the camera configuration stream that are consistent with the first configuration parameters, the higher the matching degree between the camera configuration stream and the first configuration parameters.

In an embodiment, the obtaining the camera data of the target camera from the image stream replica based on the first camera configuration stream includes:
in response to that the configuration parameters contained in the first camera configuration stream are all consistent with the first configuration parameters, obtaining, based on the first camera configuration stream, at least one frame of image from the image stream replica as the camera data obtained from the target camera; or
in response to that there are configuration parameters contained in the first camera configuration stream that are inconsistent with the first configuration parameters, obtaining at least one frame of image from the image stream replica based on the first camera configuration stream, performing image conversion on all obtained images, and taking the converted images as the camera data obtained from the target camera, wherein image parameters of the converted images are the first configuration parameters.

In an embodiment, after the copying the image stream to obtain the image stream replica, the method further includes:
uploading the image stream replica to a preset server, and returning to execute the receiving the camera access request; and
after the taking the camera requested to be accessed as the target camera, the method further includes:
determining an application requesting access to the target camera according to the camera access request; and
in response to that the application requesting access to the target camera is a non-native application, obtaining the camera data of the target camera from the image stream replica uploaded to the preset server.

Furthermore, to achieve the above objectives, the present application also provides an apparatus for obtaining camera data, including:
a receiving module, configured to receive a camera access request, and take a camera requested to be accessed as a target camera;
a sharing module, configured to, in response to that the target camera is not in use when the camera access request is received, run a system camera support component, obtain an image stream captured by the target camera through the system camera support component, obtain camera data of the target camera from the image stream, and copy the image stream to obtain an image stream replica; and
an obtaining module, configured to, in response to that the target camera is already in use when the camera access request is received, run the system camera support component, and obtain the camera data of the target camera from the image stream replica through the system camera support component.

In addition, to achieve the above objectives, the present application also provides an augmented reality device, which includes a microphone array and a processor. The microphone array is electrically connected to the processor, and the processor is configured to execute the steps of the method for obtaining camera data described above.

In addition, to achieve the above objectives, the present application also provides a readable storage medium, which is a computer-readable storage medium, and stores a program for implementing the method for obtaining camera data. The program for implementing the method for obtaining camera data is executed by a processor to implement the steps of the method for obtaining camera data as described above.

The present application also provides a computer program product, including a computer program that, when executed by a processor, implements the steps of the method for obtaining camera data described above.

In the present application, the augmented reality device receives a camera access request and takes the requested camera as the target camera. If the target camera is not in use when the camera access request is received, the system camera support component is run, the image stream captured by the target camera is obtained through the system camera support component, the camera data of the target camera is obtained from the image stream, and the image stream copied to obtain an image stream replica. If the target camera is in use when the camera access request is received, the system camera support component is run, and the camera data of the target camera is obtained from the image stream replica. Thus, in the embodiment of the present application, when the target camera is not in use, the image stream captured by the target camera is backed up. When a subsequent process uses the target camera again, it can obtain the camera data from the backup image stream replica without having to obtain the image stream of the target camera again. Therefore, the process that initially uses the target camera uses the target camera based on the obtained image stream, and subsequent processes that use the target camera again use the target camera indirectly based on the backup image stream replica, rather than directly accessing or controlling the target camera. Based on the backup image stream replica, multiple processes can indirectly share the use of the target camera, enabling multiple processes to share the same camera of the AR device. For example, when the AR device plays the original sound track (OST) based on the captured current scene or uses virtual studio technology (VST) to edit and process the audio content in the AR experience based on the captured current scene, gesture control can be supported simultaneously.

### BRIEF DESCRIPTION OF THE DRAWINGS

The accompanying drawings, which are incorporated in and form part of this specification, illustrate embodiments consistent with the present application and, together with the specification, serve to explain the principles of the present application.

To more clearly illustrate the technical solutions in the embodiments of the present application or the related art, the drawings used in the description of the embodiments or the related art will be briefly introduced below. Obviously, for those skilled in the art, other drawings can be obtained based on these drawings without creative efforts.

FIG. 1 is a flowchart of a method for obtaining camera data according to an embodiment of the present application.

FIG. 2 is a simplified flowchart of a method for obtaining camera data according to an embodiment of the present application.

FIG. 3 is a flowchart of a method for obtaining camera data of according to another embodiment the present application.

FIG. 4 is a structure diagram of an apparatus for obtaining camera data of the present application.

FIG. 5 is a structure diagram of a hardware operating environment involved in an apparatus for obtaining camera data according to an embodiments of the present application;

FIG. 6 is a flowchart of a method for obtaining camera data according to an embodiment of the present application;

FIG. 7 is a flowchart of a method for obtaining camera data according to an embodiment of the present application;

FIG. 8 is a flowchart of a method for obtaining camera data according to an embodiment of the present application;

FIG. 9 is a flowchart of a method for obtaining camera data according to an embodiment of the present application;

FIG. 10 is a flowchart of a method for obtaining camera data according to an embodiment of the present application.

The purpose, features, and advantages of the present application will be further explained in conjunction with the embodiments and with reference to the accompanying drawings.

### DETAILED DESCRIPTION OF THE EMBODIMENTS

To make the above-mentioned objects, features, and advantages of the present application more apparent and understandable, the technical solutions of the embodiments of the present application will be clearly and completely described below with reference to the accompanying drawings. Obviously, the described embodiments are only some embodiments of the present application, and not all embodiments. Based on the embodiments of the present application, all other embodiments obtained by those skilled in the art without creative effort are within the scope of protection of the present application.

In AR devices, when one process is using the camera, other processes cannot access the camera at the same time. This is because the camera is a hardware resource, and the operating system usually does not allow two different processes to directly control the same hardware resource at the same time.

Based on this, the main solution of the present application is: receiving a camera access request, and taking a camera requested to be accessed as a target camera; if the target camera is not in use when the camera access request is received, running a system camera support component, obtaining an image stream captured by the target camera through the system camera support component, obtaining camera data of the target camera from the image stream, and copying the image stream to obtain an image stream replica; if the target camera is already in use when the camera access request is received, running the system camera support component, and obtaining the camera data of the target camera from the image stream replica through the system camera support component.

In the present application, when the target camera is not in use, the image stream captured by the target camera is backed up. When a subsequent process uses the target camera again, it can obtain the camera data from the backed-up image stream replica without having to obtain the image stream of the target camera again. Thus, the process that initially uses the target camera uses the target camera based on the obtained image stream, and subsequent processes that use the target camera again use the target camera indirectly based on the backed-up image stream replica, rather than directly accessing or controlling the target camera. Based on the backed-up image stream replica, multiple processes can indirectly share the use of the target camera, enabling multiple processes to share the same camera of the AR device.

It should be noted that the execution subject of each embodiment of the method for obtaining camera data of the present application is an augmented reality device capable of realizing the above-mentioned functions, such as AR glasses, AR helmets, etc. For example, AR glasses are used as the execution subject in the description of each embodiment of the present application.

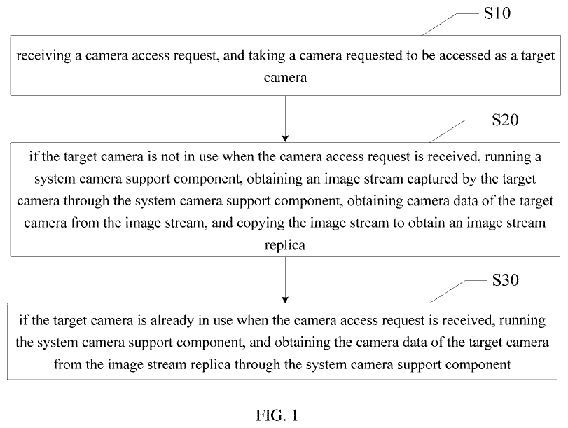

Based on this, the present application proposes a method for obtaining camera data according to an embodiment. As shown in FIG. 1, the method for obtaining camera data includes steps S10 to S30.

Step S10: receiving a camera access request, and taking a camera requested to be accessed as a target camera.

It should be noted that the AR glasses can be AR glasses based on the Android camera system, but are not limited to AR glasses based on the Android camera system. For example, they can also be AR glasses based on iphone operating system (IOS). This embodiment does not impose any specific limitations on this.

AR glasses need to perform corresponding tasks based on the camera data captured by the camera. For example, when AR glasses perform gesture control, they need to obtain the camera data captured by the camera to recognize the user's gestures and then perform subsequent control based on the recognized gestures. When AR glasses play OST, in order to improve the user experience, they need to obtain the camera data captured by the camera to recognize the current scene in which the user is located and then play the OST corresponding to that scene.

When an application in AR glasses needs to obtain camera data from a certain camera, that is, when it needs to use the camera, it can initiate a camera access request for that camera through a process. Specifically, the process can encapsulate the camera identifier of the camera in the camera access request to determine the target camera to be accessed in this request based on the camera identifier encapsulated in the camera access request.

It should be noted that after a process initiates a camera access request to the target camera, if the AR glasses receive the process's access request, the process can obtain the target camera's camera data. In other words, the process starts using the target camera. During the use of the target camera, the process will not send any more camera access requests. It only needs to initiate a camera stop access request when the process no longer needs to use the target camera to terminate the continued acquisition of the camera data of the target camera, that is, to terminate the use of the target camera.

Step S20: if the target camera is not in use when the camera access request is received, running a system camera support component, obtaining an image stream captured by the target camera through the system camera support component, obtaining camera data of the target camera from the image stream, and copying the image stream to obtain an image stream replica.

For ease of subsequent explanation and clarification, if the target camera is not in use when the camera access request is received, the process that accesses the target camera will be recorded as the process that accesses the target camera for the first time.

The image stream is specifically composed of image frames captured by the target camera at a preset shooting frequency.

The camera data of the target camera is obtained from the image stream. Specifically, one frame, multiple frames, or all frames can be obtained from the image stream as the camera data of the target camera. It is easy to understand that different processes have different requirements for the image frames they need to obtain. For example, the gesture recognition process may need to obtain all image frames, while the photo capture process may only need to obtain one image frame. Based on this, the corresponding image frame can be obtained from the image stream as the obtained camera data based on the characteristics of the process itself.

Furthermore, after obtaining an image stream replica, the access interface of the image stream replica can be shared (such as the storage address of the image stream replica), so that subsequent processes accessing the target camera can access the image stream replica through the shared stream access interface.

It is understandable that the architecture of the AR glasses' camera system includes, in sequence, the application layer, the framework layer, the hardware abstraction layer (HAL), and the hardware layer. The HAL implements interfaces related to specific hardware, abstracting the implementation details of different camera hardware. This allows the camera system to access camera devices from different manufacturers in a unified way. Specifically, the CameraProvider is a key system-level component of the HAL layer, responsible for managing and providing access interfaces to the camera hardware. It provides information and status of the camera devices to the upper-layer CameraManager service and handles operations such as opening, configuring, transmitting data streams, and closing the camera devices. Based on this, in this embodiment, the system camera support component is specifically the CameraProvider.

Step S30: if the target camera is already in use when the camera access request is received, running the system camera support component, and obtaining the camera data of the target camera from the image stream replica through the system camera support component.

For ease of subsequent explanation and clarification, if the target camera is already in use when the camera access request is received, then the process that accesses the target camera will be recorded as the process that accesses the target camera again.

The process that accesses the target camera for the first time obtains camera data from the original image stream, while subsequent processes that access the target camera again obtain camera data from an image stream replica. Thus, subsequent processes that access the target camera again are actually using the target camera indirectly through an image stream replica. In contrast, the process that accesses the target camera for the first time is actually using the target camera independently using the original camera usage logic of the AR glasses.

All processes obtain camera data through the existing CameraProvider camera support component in the camera system. This requires minimal modification to the camera system architecture, thereby reducing the implementation cost of sharing cameras.

In this embodiment, the augmented reality device receives a camera access request and takes the requested camera as the target camera. If the target camera is not in use when the camera access request is received, the system camera support component is run, the image stream captured by the target camera is obtained through the system camera support component, the camera data is obtained from the image stream, and copy the image stream to obtain an image stream replica. If the target camera is in use when the camera access request is received, the system camera support component is run, the camera data of the target camera is obtained from the image stream replica through the system camera support component. Thus, in this embodiment, when the target camera is not in use, the image stream captured by the target camera is backed up. When a subsequent process uses the target camera again, it can obtain the camera data from the backup image stream replica without having to obtain the target camera's image stream again. Therefore, the process that initially uses the target camera uses the target camera based on the obtained image stream, and subsequent processes that use the target camera again use the target camera indirectly based on the backup image stream replica, rather than directly accessing or controlling the target camera. Based on the backup image stream replica, multiple processes can indirectly share the use of the target camera, enabling multiple processes to share the same camera of the AR device. For example, when the AR device plays the OST based on the captured current scene or uses VST to edit and process the audio content in the AR experience based on the captured current scene, gesture control can be supported simultaneously.

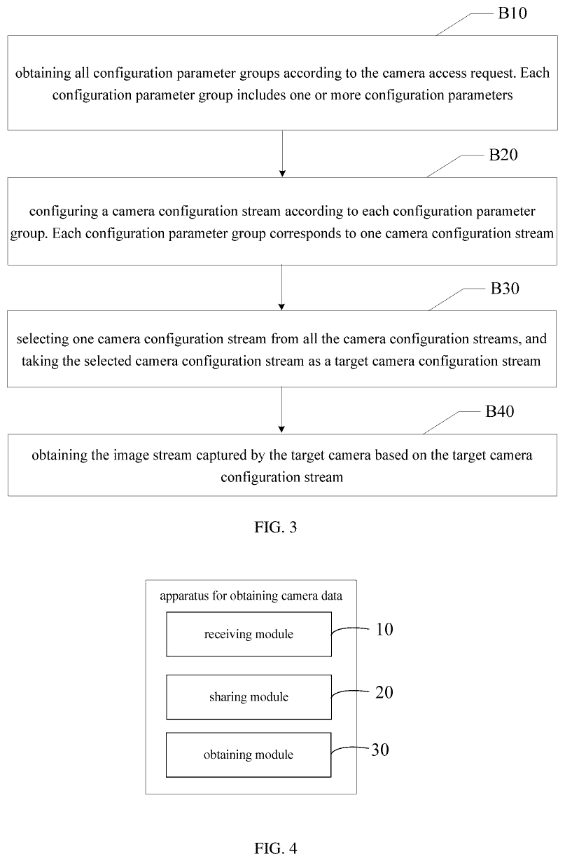

Based on the above embodiments of the present application, in this embodiment of the present application, the content that is the same as or similar to that in the above embodiments described above can be referred to the above description and will not be repeated hereafter. Based on this, as shown in FIG. 3, the step of obtaining the image stream captured by the target camera includes:

Step B10: obtaining all configuration parameter groups according to the camera access request. Each configuration parameter group includes one or more configuration parameters.

Furthermore, when the configuration parameter group includes multiple configuration parameters, these multiple configuration parameters are specifically multiple configuration parameters of different parameter types. Specifically, the parameter types of the configuration parameters include, but are not limited to, image format, color space, and resolution. This embodiment does not impose specific restrictions on these, and the parameter types that need to be configured when configuring the camera stream (i.e., camera configuration stream) in the actual camera system shall prevail.

Furthermore, based on different parameter types, the configuration parameters encapsulated in the camera access request and the configuration parameters supported by the AR glasses are permuted and combined to obtain all configuration parameter groups. For example, assuming each configuration parameter group includes configuration parameters of two types: image format and resolution, and the configuration parameters encapsulated in the camera access request are [Format A, Resolution A]. For the image format parameter type, the AR glasses support configuration parameters of format B and format C; for the resolution parameter type, the AR glasses support configuration parameters of resolution A and resolution B. Then, the configuration parameter groups obtained by permuting and combining different parameter types are [Format A, Resolution A], [Format A, Resolution B], [Format B, Resolution A], [Format B, Resolution B], [Format C, Resolution A], and [Format C, Resolution B].

Step B20: configuring a camera configuration stream according to each configuration parameter group. Each configuration parameter group corresponds to one camera configuration stream.

The specific configuration method for the camera configuration stream in the configuration parameter group can use the existing camera configuration stream configuration method in the Android camera system HAL layer. This embodiment will not detail the camera configuration stream configuration process. It should be noted that after each camera configuration stream is configured, it includes the configuration parameters in the configuration parameter group and a generated pipeline. The pipeline is a channel in the HAL layer used to manage image data streams. It ensures that image data is transmitted efficiently and consistently, while handling possible data format conversions. The pipeline may include multiple processing stages, such as noise reduction, white balance adjustment, color correction, cropping, and scaling. These processing stages help improve image quality and meet the needs of specific applications. The pipeline can be understood as a channel for transmitting image streams. The configuration parameters in the configuration parameter group are used to indicate the processing target of the pipeline.

Step B30: selecting one camera configuration stream from all the camera configuration streams, and taking the selected camera configuration stream as a target camera configuration stream.

When AR glasses obtain an image stream, they need to obtain it based on a camera configuration stream. Based on this, a target camera configuration stream can be randomly selected from all camera configuration streams or selected based on preset rules in order to successfully obtain the image stream.

Step B40: obtaining the image stream captured by the target camera based on the target camera configuration stream.

The acquisition of image streams based on the target camera configuration stream can specifically be achieved by obtaining the image stream through the pipeline in the target camera configuration stream. The pipeline outputs an image stream with the configured parameter data format. The actual obtained image stream can be understood as the stream data output after passing through the pipeline.

It is understandable that the HAL layer of the camera system can only configure the camera configuration stream once for the same camera. Based on this, in this embodiment, upon receiving the camera access request from the process accessing the target camera for the first time, the system configures not only the camera configuration stream based on the configuration parameters encapsulated in the camera access request, but also all camera configuration streams based on the configuration parameters supported by the AR glasses. In this way, the camera configuration stream of subsequent processes accessing the target camera is pre-configured so that subsequent processes accessing the target camera can obtain image streams based on the pre-configured camera configuration streams. This allows the AR glasses to support different processes obtaining image streams based on different camera configuration streams, and the image streams obtained by different camera configuration streams have different formats, enabling the AR glasses to support the acquisition of multi-format image streams and improving the intelligence of sharing camera.

In an implementation, as shown in FIG. 6, the step of selecting one camera configuration stream from all the camera configuration streams, and taking the selected camera configuration stream as the target camera configuration stream includes:

Step C10: taking, as the target camera configuration stream, the camera configuration stream configured based on configuration parameters encapsulated in the camera access request among all the camera configuration streams.

In this embodiment, the camera configuration stream obtained based on the configuration parameters encapsulated in the camera access request is used as the target camera configuration stream. It can be understood that the process usually encapsulates the data format it expects to obtain in the form of configuration parameters in the camera access request. In this way, the data format of the image stream obtained based on the target camera configuration stream can meet the expectations of the process accessing the target camera for the first time.

Based on the above embodiments of the present application, in this embodiment of the present application, the content that is the same as or similar to the above embodiments described above can be referred to the above description and will not be repeated hereafter. Based on this, as shown in FIG. 7, the step of obtaining the camera data of the target camera from the image stream replica includes:

Step D10: obtaining all pre-configured camera configuration streams, and selecting a first camera configuration stream from all the camera configuration streams.

All pre-configured camera configuration streams are specifically all the camera configuration streams configured when the target camera is accessed for the first time.

The first camera configuration stream can be selected randomly from all camera configuration streams or selected based on preset rules from those that are not currently in use. The phrase “camera configuration stream that are not currently in use” indicates that the camera configuration stream is not currently being used by the camera system to obtain image streams.

Step D20: obtaining the camera data of the target camera from the image stream replica based on the first camera configuration stream.

Understandably, in a camera system, it is necessary to obtain the image stream of the camera based on the camera configuration stream. Therefore, in this embodiment, camera data is obtained from an image stream replica based on the selected first camera configuration stream. The actual image stream obtained is the stream data output from the image stream replica after being processed through the pipeline in the first camera configuration stream.

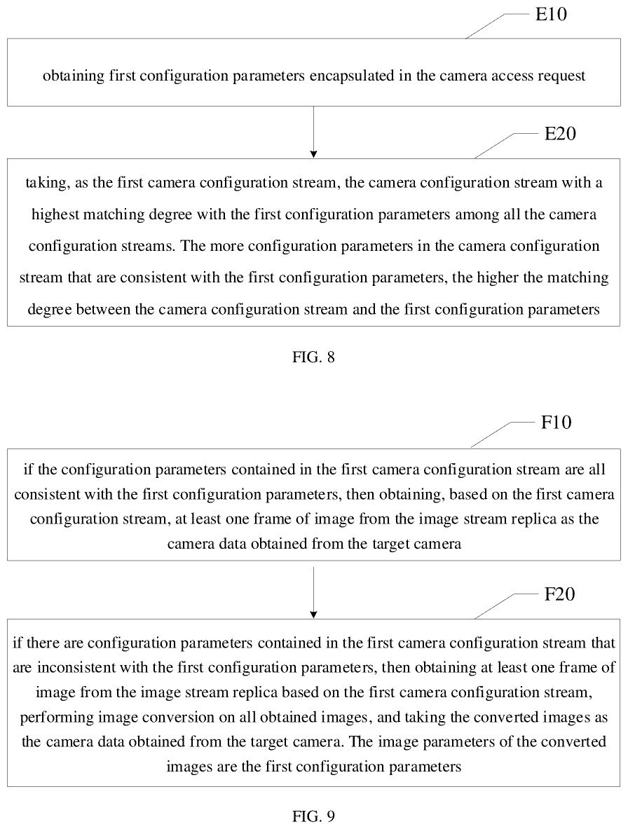

In an implementation, as shown in FIG. 8, the step of selecting the first camera configuration stream from all the camera configuration streams includes:

Step E10: obtaining first configuration parameters encapsulated in the camera access request.

Step E20: taking, as the first camera configuration stream, the camera configuration stream with a highest matching degree with the first configuration parameters among all the camera configuration streams. The more configuration parameters in the camera configuration stream that are consistent with the first configuration parameters, the higher the matching degree between the camera configuration stream and the first configuration parameters.

Furthermore, if there are multiple camera configuration streams with the highest matching degree, then any one of the multiple camera configuration streams with the highest matching degree can be selected as the first camera configuration stream.

It should be noted that for a camera configuration stream, the more configuration parameters in the camera configuration stream that are consistent with the first configuration parameter, the higher the matching degree between the camera configuration stream and the first configuration parameter.

In an implementation, the total number of configuration parameters in the camera configuration stream that are consistent with the first configuration parameter can be used as the matching degree between the camera configuration stream and this first camera configuration parameter. For example, assuming the first configuration parameter is [Format A, Color Space A, Resolution A], and there are camera configuration stream A, camera configuration stream B, and camera configuration stream C, whose configuration parameters are [Format A, Color Space B, Resolution C], [Format A, Color Space A, Resolution B], and [Format A, Color Space A, Resolution A] respectively, then the matching degree between camera configuration stream A and the first configuration parameter is 1, the matching degree between camera configuration stream B and the first configuration parameter is 2, and the matching degree between camera configuration stream C and the first configuration parameter is 3. In this case, camera configuration stream C has the highest matching degree, and camera configuration stream C is selected as the first camera configuration stream.

As another implementation, a corresponding weight can be set for each configuration parameter, and a weighted summation is performed based on the weights to calculate the matching degree between the camera configuration stream and the first configuration parameter. For example, assuming the first configuration parameter is [Format A, Color space A, Resolution A], and the weights corresponding to image format, color space, and resolution are 0.1, 0.7, and 0.2 respectively. There are camera configuration stream A, camera configuration stream B, and camera configuration stream C, whose configuration parameters are [Format A, Color pace B, Resolution C], [Format A, Color space A, Resolution B], and [Format A, Color space A, Resolution A] respectively, then the matching degree between camera configuration stream A and the first configuration parameter is 0.1, the matching degree between camera configuration stream B and the first configuration parameter is 0.8, and the matching degree between camera configuration stream C and the first configuration parameter is 1. In this case, camera configuration stream C has the highest matching degree, and camera configuration stream C is selected as the first camera configuration stream.

It should be noted that the above are only two implementation methods for calculating the matching degree between the camera configuration stream and the first configuration parameter provided in this embodiment. This embodiment does not specifically limit the specific implementation method for calculating the matching degree between the camera configuration stream and the first configuration parameter.

In this embodiment, the camera configuration stream with the highest matching degree with the first configuration parameter is selected as the first camera configuration stream. It can be understood that the process usually encapsulates the data format it expects to obtain in the form of configuration parameters in the camera access request. In this way, the data format of the image stream obtained based on the first camera configuration stream can be as close as possible to the data format expected by the process accessing the target camera, that is, the matching degree between the obtained data format and the expected data format is maximized, so as to reduce the amount of subsequent data format conversion.

In an implementation, as shown in FIG. 9, the step of obtaining the camera data of the target camera from the image stream replica based on the first camera configuration stream includes:

Step F10: if the configuration parameters contained in the first camera configuration stream are all consistent with the first configuration parameters, then obtaining, based on the first camera configuration stream, at least one frame of image from the image stream replica as the camera data obtained from the target camera.

The configuration parameters in the first camera configuration stream are identical to the first configuration parameter, that is, the parameter values are exactly the same. For example, assuming a configuration parameter includes image format, color space, and resolution, then the configuration parameters in the first camera configuration stream are identical to the first configuration parameter. Specifically, the image format, color space, and resolution in the first camera configuration stream are identical to those in the first configuration parameter. Since the configuration parameters are completely identical, the image stream obtained from the first camera configuration stream is in the expected data format, and no data format conversion is required.

Step F20: if there are configuration parameters contained in the first camera configuration stream that are inconsistent with the first configuration parameters, then obtaining at least one frame of image from the image stream replica based on the first camera configuration stream, performing image conversion on all obtained images, and taking the converted images as the camera data obtained from the target camera. The image parameters of the converted images are the first configuration parameters.

At least one frame of image is obtained from the shared image stream replica corresponding to the first camera configuration stream. The specific number and types of frames obtained can be determined based on the process's own needs, and this implementation does not impose any specific restrictions on this.

Image conversion is performed on all obtained images. Specifically, conversion can be performed based on inconsistent configuration parameters. For example, suppose the configuration parameters of the first camera configuration stream are [Format A, Color space A, Resolution B], and the first configuration parameter is [Format A, Color space A, Resolution A]. The image format and color space are consistent, but the resolutions are inconsistent, the obtained images can be scaled to scale resolution B to resolution A, thereby obtaining the converted image, so that the converted data format meets expectations.

In this embodiment, when the configuration parameters in the first camera configuration stream are inconsistent with the first configuration parameters, the image is converted to convert the image parameters such as image format, color space, and resolution into the first configuration parameters, so that the data format of the obtained camera data conforms to the process expectation.

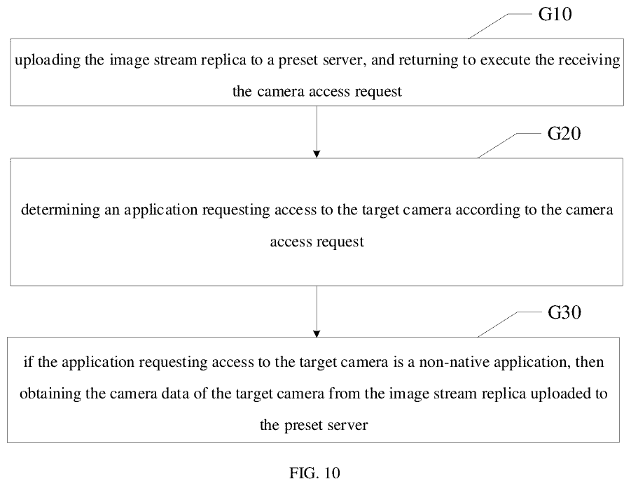

Based on the above embodiments of the present application, in this embodiment of the present application, the content that is the same as or similar to the above-described embodiments can be referred to the above description and will not be repeated hereafter. In addition, as shown in FIG. 10, after the step of copying the image stream to obtain an image stream replica, the method for obtaining the camera data further includes:

Step G10: uploading the image stream replica to a preset server, and returning to execute the receiving the camera access request.

Upload an image stream replica to a preset server. Specifically, the image stream replica can be copied to the preset server, or the original image stream can be copied to the preset server. This embodiment does not impose any specific restrictions on this.

After the step of the taking the camera requested to be accessed as the target camera, the method for obtaining the camera data further includes:

Step G20: determining an application requesting access to the target camera according to the camera access request.

Step G30: if the application requesting access to the target camera is a non-native application, then obtaining the camera data of the target camera from the image stream replica uploaded to the preset server.

Native applications refer to applications that can run directly on the current operating system and are specifically developed for a particular operating system, such as IOS or Android. Native applications are built using specific programming languages for specific device platforms. Non-native applications specifically refer to applications that are distinct from native applications, such as user-defined applications and web (World Wide Web) applications. In this embodiment, non-native applications may specifically be applications that cannot run directly on the current operating system of AR glasses.

In this embodiment, non-native applications obtain camera data from a preset server. This allows non-native applications to share and use the camera, and directly obtaining camera data from the preset server improves the acquisition speed, achieving low-latency acquisition of camera data.

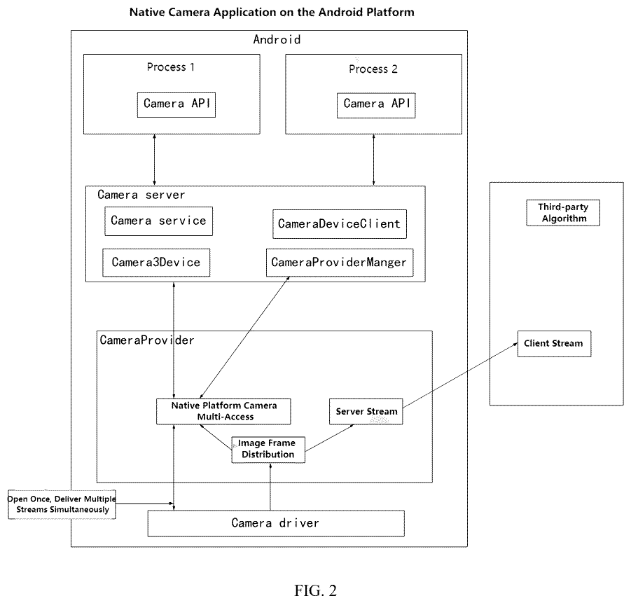

For example, to help understand the technical concept or principle of camera data acquisition in combination with the above-described embodiments, as shown in FIG. 2, FIG. 2 provides a simplified flowchart of a method for obtaining camera data, as follows:

Process A and process B access the same camera through the Android camera system's camera application programming interface (Camera API). Process A and process B are native processes of the Camera application on the Android platform.

In the Camera server (system camera service) module, if a camera that is already in use is opened, since the camera system can only assign a camera identifier to one process for the same camera, a virtual camera identifier is generated and passed to the HAL layer. This allows the camera system to accept the access request from that process for further processing, instead of kicking out the process that is currently using the camera or directly rejecting its access request. The Camera server module is the native Camera server module of the Android camera system, including native Android camera system modules such as Camera service, CameraDeviceClient, Camera3Device, and CameraProviderManager.

In the Camera provider module, when an unused camera is opened, all camera streams are configured (including all image formats, color spaces, and resolutions, generating all pipelines), and all camera streams are sent to the Camera driver. The retrieved image streams are cached and copied. When the same camera is opened a second time, the requested camera is marked, and an image stream replica is obtained, achieving data sharing.

The image frames in the image stream are distributed to the server (server stream shown in FIG. 2). When the third-party algorithm in the non-native application needs to use the camera, it obtains the camera data from the server and transmits the image stream from the server to the client of the non-native application (client stream shown in FIG. 2).

It should be noted that the above specific embodiments are only used to understand the present application and do not constitute a limitation on the camera data acquisition process of the present application. Any simple modifications based on this technical concept are all within the protection scope of the present application.

Furthermore, the present application also provides an apparatus for obtaining camera data. As shown in FIG. 4, the apparatus for obtaining camera data includes a receiving module 10, a sharing module 20 and an obtaining module 30.

The receiving module 10 is configured to receive camera access request and to take the camera requested to be accessed as the target camera.

The sharing module 20 is configured to run the system camera support component if the target camera is not in use when the camera access request is received, to obtain the image stream captured by the target camera through the system camera support component, to obtain the camera data of the target camera from the image stream, and to copy the image stream to obtain an image stream replica.

The obtaining module 30 is configured to run the system camera support component if the target camera is already in use when the camera access request is received, and to obtain the camera data of the target camera from the image stream replica through the system camera support component.

Furthermore, the present application also proposes an augmented reality device, which includes a memory, a processor, and a program for obtaining camera data stored in the memory and executable on the processor. When the program for obtaining camera data is executed by the processor, it implements the steps of the method for obtaining camera data described above.

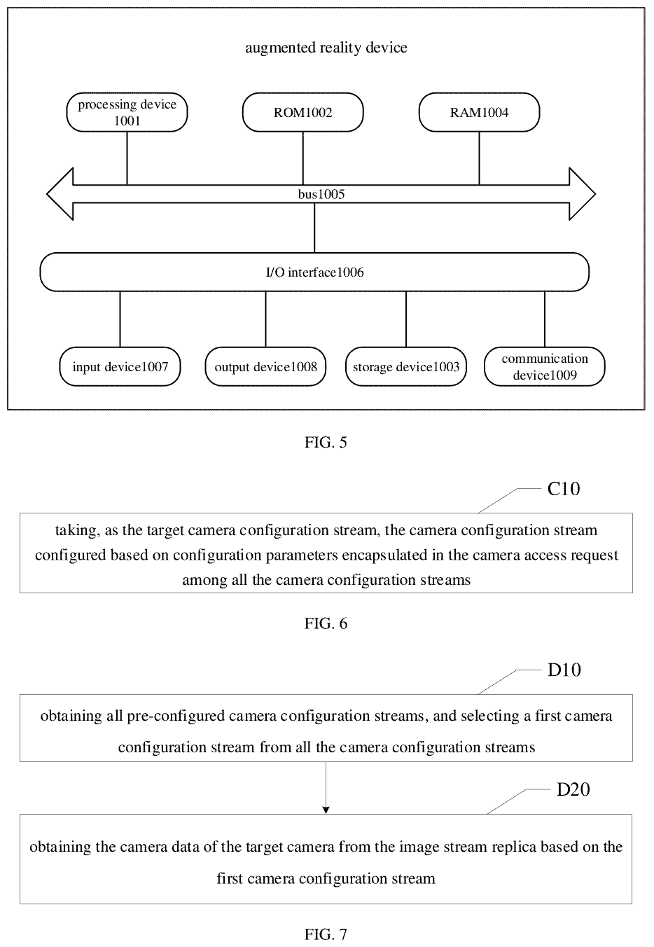

Furthermore, as shown in FIG. 5, the augmented reality device may also include a processing device 1001 (e.g., a central processing unit, a graphics processing unit, etc.), which can perform various appropriate actions and processes according to a program stored in read only memory (ROM) 1002 or a program loaded from storage device 1003 into random access memory (RAM) 1004. The RAM 1004 also stores various programs and data required for the operation of the augmented reality device. The processing device 1001, ROM 1002, and RAM 1004 are interconnected via a bus 1005. An input/output (I/O) interface 1006 is also connected to the bus. Typically, the following systems can be connected to the I/O interface 1006: input device 1007 including, for example, touchscreens, touchpads, image sensors, microphones, accelerometers, gyroscopes, etc.; output device 1008 including, for example, liquid crystal display (LCD), speakers, vibrators, etc.; storage device 1003 including, for example, magnetic tapes, hard disks, etc.; and communication device 1009. The communication device 1009 allows the augmented reality device to communicate wirelessly or wiredly with other devices to exchange data. While the figures show augmented reality devices with various systems, it should be understood that implementing or having all of the systems shown is not required. More or fewer systems may be implemented alternatively.

Specifically, according to the embodiments disclosed in the present application, the processes described above with reference to the flowcharts can be implemented as computer software programs. For example, embodiments disclosed in the present application include a computer program product including a computer program carried on a computer-readable medium, the computer program containing program code for performing the methods shown in the flowcharts. In such embodiments, the computer program can be downloaded and installed from a network via a communication device 1009, or installed from storage device 1003, or installed from ROM 1002. When the computer program is executed by processing device 1001, it performs the functions defined in the methods of the embodiments disclosed in the present application.

The augmented reality device provided in the present application, employing the method for obtaining camera data described in the above embodiments, can solve the technical problem of camera data acquisition. Compared with the related art, the beneficial effects of the augmented reality device provided in the present application are the same as those of the method for obtaining camera data provided in the above embodiments, and other technical features of this augmented reality device are the same as those disclosed in the method of the previous embodiment, and will not be repeated here.

It should be understood that the various parts disclosed in the present application can be implemented using hardware, software, firmware, or a combination thereof. In the description of the above embodiments, specific features, structures, materials, or characteristics can be combined in any suitable manner in one or more embodiments or examples.

The above description is merely a specific embodiment of the present application, but the scope of protection of the present application is not limited thereto. Any variations or substitutions that can be easily conceived by those skilled in the art within the scope of the technology disclosed in the present application should be included within the scope of protection of the present application. Therefore, the scope of protection of the present application should be determined by the scope of the claims.

In addition, to achieve the above objectives, the present application also provides a readable storage medium having computer-readable program instructions (i.e., a computer program) stored thereon, which are configured to execute the method for obtaining camera data in the above embodiments.

The computer-readable storage medium provided in the present application embodiment may be, for example, a universal serial bus flash disk, but is not limited to, electrical, magnetic, optical, electromagnetic, infrared, or semiconductor systems, devices, or any combination thereof. More specific examples of computer-readable storage medium may include, but are not limited to: electrical connections with one or more wires, portable computer disks, hard disks, RAM, ROM, erasable programmable read only memory (EPROM or flash memory), optical fibers, portable compact disk read only memory (CD-ROM), optical storage devices, magnetic storage devices, or any suitable combination thereof. In this embodiment, the computer-readable storage medium may be any tangible medium containing or storing a program that can be used by or in conjunction with an instruction execution system, system, or device. The program code contained on the computer-readable storage medium may be transmitted using any suitable medium, including but not limited to: wires, optical cables, radio frequency (RF), etc., or any suitable combination thereof.

The aforementioned computer-readable storage medium may be included in the augmented reality device; or it may exist independently and not incorporated into the augmented reality device.

The aforementioned computer-readable storage medium carries one or more programs that, when executed by an augmented reality device, cause the augmented reality device to: receive a camera access request and take the requested camera as the target camera; if the target camera is not in use when the camera access request is received, then run a system camera support component, obtain an image stream captured by the target camera through the system camera support component, obtain the camera data of the target camera from the image stream, and copy the image stream to obtain an image stream replica; if the target camera is in use when the camera access request is received, then run the system camera support component and obtain the camera data of the target camera from the image stream replica through the system camera support component.

Computer program code for performing the operations of the present application can be written in one or more programming languages or a combination thereof, including object-oriented programming languages such as Java, Smalltalk, and C++, and conventional procedural programming languages such as the “C” language or similar programming languages. The program code can be executed entirely on the user's computer, partially on the user's computer, as a standalone software package, partially on the user's computer and partially on a remote computer, or entirely on a remote computer or server. In cases involving remote computers, the remote computer can be connected to the user's computer via any type of network—including a local area network (LAN) or a wide area network (WAN)—or can be connected to an external computer (e.g., via the Internet using an Internet service provider).

The flowcharts and block diagrams in the accompanying drawings illustrate the architecture, functionality, and operation of possible implementations of systems, methods, and computer program products according to various embodiments of the present application. In this regard, each block in a flowchart or block diagram may represent a module, segment, or portion of code containing one or more executable instructions for implementing a specified logical function. It should also be noted that in some alternative implementations, the functions indicated in the blocks may occur in a different order than those indicated in the drawings. For example, two consecutively indicated blocks may actually be executed substantially in parallel, and they may sometimes be executed in reverse order, depending on the functions involved. It should also be noted that each block in the block diagrams and/or flowcharts, and combinations of blocks in the block diagrams and/or flowcharts, can be implemented using a dedicated hardware-based system that performs the specified function or operation, or using a combination of dedicated hardware and computer instructions.

The modules described in the embodiments of the present application can be implemented in software or hardware. The names of the modules do not necessarily limit the functionality of the unit itself.

The readable storage medium provided in the present application is a computer-readable storage medium that stores computer-readable program instructions (i.e., a computer program) for executing the above-described method for obtaining camera data, thereby solving the technical problem of camera data acquisition. Compared with the prior art, the beneficial effects of the computer-readable storage medium provided in the present application are the same as the beneficial effects of the method for obtaining camera data provided in the above embodiments, and will not be repeated here.

Furthermore, the present application also proposes a computer program product, including a program for obtaining camera data, which, when executed by a processor, implements the steps of the method for obtaining camera data described above.

The specific implementation of the computer program product in the present application is basically the same as the embodiments of the above-described method for obtaining camera data, and will not be repeated here.

It should be noted that, in this document, the terms “comprise”, “include” or any other variations thereof are intended to cover non-exclusive inclusion, such that a process, method, article, or system that includes a list of elements includes not only those elements but also other elements not expressly listed, or elements inherent to such a process, method, article, or system. Unless otherwise specified, an element defined by the phrase “include a . . . ” does not exclude the presence of other identical elements in the process, method, article, or system that includes that element.

The above-mentioned serial numbers of the embodiments of the present application are merely for description and do not represent the superiority or inferiority of the embodiments.

Through the above description of the embodiments, those skilled in the art can clearly understand that the methods of the above embodiments can be implemented by means of software plus necessary general-purpose hardware platforms. Of course, they can also be implemented by hardware, but in many cases the former is a better implementation method. Based on this understanding, the technical solution of the present application, in essence, or the part that contributes to the prior art, can be embodied in the form of a software sensor. This computer software sensor is stored in a storage medium (such as ROM/RAM, magnetic disk, optical disk) as described above, and includes several instructions to cause a terminal device (which may be a mobile phone, computer, server, air conditioner, or network device, etc.) to execute the methods described in the various embodiments of the present application.

The above are merely preferred embodiments of the present application and do not limit the patent scope of the present application. Any equivalent structural or procedural transformations made using the content of the present application's specification and drawings, or direct or indirect applications in other related technical fields, are similarly included within the patent protection scope of the present application.

What is claimed is:

1. A method for obtaining camera data, applied to an augmented reality device, comprising:
receiving a camera access request, and taking a camera requested to be accessed as a target camera;
in response to that the target camera is not in use when the camera access request is received, running a system camera support component, obtaining an image stream captured by the target camera through the system camera support component, obtaining camera data of the target camera from the image stream, and copying the image stream to obtain an image stream replica; or
in response to that the target camera is already in use when the camera access request is received, running the system camera support component, and obtaining the camera data of the target camera from the image stream replica through the system camera support component.

2. The method according to claim 1, wherein the obtaining the image stream captured by the target camera comprises:
obtaining all configuration parameter groups according to the camera access request, wherein each configuration parameter group comprises one or more configuration parameters;
configuring a camera configuration stream according to each configuration parameter group, wherein each configuration parameter group corresponds to one camera configuration stream;
selecting one camera configuration stream from all the camera configuration streams, and taking the selected camera configuration stream as a target camera configuration stream; and
obtaining the image stream captured by the target camera based on the target camera configuration stream.

3. The method according to claim 2, wherein the selecting one camera configuration stream from all the camera configuration streams, and taking the selected camera configuration stream as the target camera configuration stream comprises:
taking, as the target camera configuration stream, the camera configuration stream configured based on configuration parameters encapsulated in the camera access request among all the camera configuration streams.

4. The method according to claim 1, wherein the obtaining the camera data of the target camera from the image stream replica comprises:
obtaining all pre-configured camera configuration streams, and selecting a first camera configuration stream from all the camera configuration streams; and
obtaining the camera data of the target camera from the image stream replica based on the first camera configuration stream.

5. The method according to claim 4, wherein the selecting the first camera configuration stream from all the camera configuration streams comprises:
obtaining first configuration parameters encapsulated in the camera access request; and
taking, as the first camera configuration stream, the camera configuration stream with a highest matching degree with the first configuration parameters among all the camera configuration streams, wherein the more configuration parameters in the camera configuration stream that are consistent with the first configuration parameters, the higher the matching degree between the camera configuration stream and the first configuration parameters.

6. The method according to claim 5, wherein the obtaining the camera data of the target camera from the image stream replica based on the first camera configuration stream comprises:
in response to that the configuration parameters contained in the first camera configuration stream are all consistent with the first configuration parameters, obtaining, based on the first camera configuration stream, at least one frame of image from the image stream replica as the camera data obtained from the target camera; or
in response to that there are configuration parameters contained in the first camera configuration stream that are inconsistent with the first configuration parameters, obtaining at least one frame of image from the image stream replica based on the first camera configuration stream, performing image conversion on all obtained images, and taking the converted images as the camera data obtained from the target camera, wherein image parameters of the converted images are the first configuration parameters.

7. The method according to claim 1, wherein:
after the copying the image stream to obtain the image stream replica, the method further comprises:
uploading the image stream replica to a preset server, and returning to execute the receiving the camera access request; and
after the taking the camera requested to be accessed as the target camera, the method further comprises:
determining an application requesting access to the target camera according to the camera access request; and
in response to that the application requesting access to the target camera is a non-native application, obtaining the camera data of the target camera from the image stream replica uploaded to the preset server.

8. An apparatus for obtaining camera data, comprising:
a receiving module, configured to receive a camera access request, and take a camera requested to be accessed as a target camera;
a sharing module, configured to, in response to that the target camera is not in use when the camera access request is received, run a system camera support component, obtain an image stream captured by the target camera through the system camera support component, obtain camera data of the target camera from the image stream, and copy the image stream to obtain an image stream replica; and
an obtaining module, configured to, in response to that the target camera is already in use when the camera access request is received, run the system camera support component, and obtain the camera data of the target camera from the image stream replica through the system camera support component.

9. An augmented reality device, comprising:
a memory;
a processor; and
a program for obtaining camera data stored on the memory and executable on the processor,
wherein the program for obtaining camera data, when executed by the processor, implements the method for obtaining the camera data according claim 1.

10. A non-transitory computer-readable storage medium, wherein a program for implementing a method for obtaining camera data is stored in the non-transitory computer-readable storage medium, and the program for implementing the method for obtaining the camera data is executed by a processor to implement the method for obtaining the camera data according to claim 1.
